(19) United States
(12) Patent Application Publication
(10) Pub. No.: US 2019/0195398 A1
(43) Pub. Date: Jun. 27, 2019

(54) FLEXIBLE HOSE LINE HAVING INTEGRATED SENSOR MATERIAL

(71) Applicant: Masterflex SE, Gelsenkirchen (DE)

(72) Inventors: Stefan Nüssen, Gelsenkirchen (DE); Enrique Seoane, Braunschweig (DE); Joachim Jacobi, Bochum (DE); Tanja Kapteina, Herne (DE); Rita Krossa, Gelsenkirchen (DE)

(73) Assignee: Masterflex SE, Gelsenkirchen (DE)

(21) Appl. No.: 16/325,216

(22) PCT Filed: Aug. 8, 2017
(86) PCT No.: PCT/EP2017/070115

§ 371 Date: Feb. 13, 2019

(30) Foreign Application Priority Data
Aug. 16, 2016 (EP) 16184348.7

(51) Int. Cl. F16L 11/112; F16L 11/24; F16L 11/118

(52) U.S. Cl. CPC F16L 11/112; F16L 11/1185; F16L 11/24

(57) ABSTRACT

The present invention relates to a flexible hose line with a wall, wherein the wall has integrated sensor material which has a material property that varies with an operating parameter of the hose line to be ascertained.

The present invention relates to a flexible hose line with integrated sensor material.

Hose lines are used in particular when flexible connections are required for transferring solids or liquid or gaseous media. The selection of a hose line generally depends on the specific requirements of the intended use, with the result that a plurality of properties of the hose line such as e.g. diameter, minimum bend radius, pressure load and temperature resistance are to be taken into account.

In many cases hose lines are used in operational plants and the operators of such plants have to use laborious measures to position measuring probes for monitoring safety-related operating parameters so that they can e.g. analyse or monitor the volume flow of a medium. For this, parts of the plant periphery often have to be laboriously reconstructed in order to bring the probe into the required position. However, in this way, conclusions as to the state of the hose line itself are not possible, or are possible only to a limited extent.

In principle it would be desirable to monitor operating and functionality parameters of an entire operational plant, i.e. not only at selected points on the plant periphery, but also the operating parameters of the hose lines included therein, preferably in real time. Thus, for example, a consistent product quality can be guaranteed and disruptions to the operating procedure can be prevented, as possible causes of disruption, such as e.g. excessive stress of the hose material, can be quickly recognized and then remedied. In this way the lifetime and reliability of hose lines can be increased, hose line failures can be minimized, the workforce can be protected and a high quality, production reliability and cost efficiency can be guaranteed.

The object of the present invention is thus to provide a flexible hose line which allows monitoring of operating and functionality parameters of the hose line in a simple manner. By way of example, the parameters to be monitored are to include, but are not limited to, the temperature of the hose wall and/or of the medium in the contact zone, the positive or negative pressure acting on the hose wall, the bend radius of the hose line, the presence of constrictions of the inner diameter of the hose line, the vibration of the hose line, the elongation or compression of the hose line, the integrity of the hose wall and the degree of ageing of the material of the hose wall.

This object is achieved by the flexible hose line according to claim 1. Advantageous embodiments of the hose line according to the invention are disclosed in the dependent claims.

The invention thus relates to a flexible hose line with a wall, wherein the wall has integrated sensor material which has a material property that varies with an operating parameter of the hose line to be ascertained.

Within the meaning of this application, by the term “flexible hose line” is meant bendable hose lines themselves, as well as hose couplings and parts thereof. The hose line usually takes the form of an elongated, cylindrical hollow body. At one or both of its ends, the hose line optionally has a hose coupling or a part of a hose coupling, a so-called fitting, by means of which the hose line can be connected to e.g. another hose line or other units, such as a fixed pipe system or other parts of a plant unit.

In a preferred embodiment of the present invention, the wall of the hose line comprises thermoplastic material. Purely by way of example and non-limitatively, silicones or thermoplastic elastomers based on urethane (TPU), i.e. polyurethane (PU), such as e.g. polyether polyurethane and polyester polyurethane, polyvinyl chloride (PVC) or polyethylene (PE) may be mentioned here, but also thermoplastic vulcanizates (TPV), such as Santroprene. Further suitable materials are, in particular, thermoplastic elastomers, such as:
TPA (thermoplastic copolyamides)
TPC (thermoplastic polyester elastomers/thermoplastic copolyesters)
TPO (thermoplastic elastomers based on olefin), e.g. PP/EPDM
TPS (styrene block copolymers, e.g. SBS, SEBS, SEPS, SEEPS and MBS).

Such thermoplastic hose lines can for example be produced in such a way that the thermoplastic material is extruded directly into the form of the desired hose line. Alternatively, the thermoplastic material can, e.g. by means of extrusion, be transformed into the form of a material web, such as e.g. an extruded profiled rim or a film web, which is then wound helically and in which longitudinal edge sections of adjacent spiral windings, or the opposite edge areas of the material web, are connected to each other overlapping. Furthermore, it is also possible that the hose wall comprises several plies or layers of the thermoplastic material which are arranged one on top of another e.g. in the form of several film plies (“sandwich construction”).

In a further preferred embodiment of the present invention, the wall of the hose line comprises a woven fabric. The material of the woven fabric is preferably selected from the group consisting of glass fibres, textile fibres, mineral fibres, aramid fibres, metallic woven fabric, such as e.g. stainless steel, such as stainless steel 1.4301, plastic fibres, such as e.g. polyamide and/or polyester fibres, and combinations thereof. The woven fabric can be uncoated or be coated with plastics and in particular the above-named thermoplastic materials or elastomers, such as e.g. Neoprene, Hypalon and Viton. Alternatively, laminations of woven fabrics with corresponding films can also be used. Such woven fabric hose lines can, for example, be produced in such a way that one or more coated or uncoated woven fabric bands are connected to form the desired hose line by means of a clamping, sewing, welding or vulcanization method.

According to a further embodiment, the wall of the hose line according to the invention, such as of a thermoplastic hose line or of a woven fabric hose line, has a reinforcing element, such as e.g. a reinforcement coil running helically. In this embodiment, the hose line according to the invention thus constitutes a so-called spiral hose. In the case of such hose lines, the reinforcing element can be completely embedded in the hose wall, with the result that it is separated from the hose interior and the hose exterior by the hose wall. It is also possible that the reinforcing element is only partially embedded in the hose wall and a section of the reinforcing element is exposed towards the hose interior or the hose exterior. It is thus possible, for example, that the reinforcing element is arranged on the outer surface of the hose wall.

Such hose lines with helically running reinforcement coil can e.g. be produced in such a way that a material web, to which the reinforcement coil is secured, is wound helically. The material web preferably comprises one or more of the above-named thermoplastic materials. A known method provides, e.g., that a material web extruded as a profiled rim is wound round a manufacturing mandrel or the like, and the part of the web already wound onto the manufacturing mandrel is pulled off therefrom axially, with the result that the web is wound on helically. The edge area of the section of web newly landing on the manufacturing mandrel is connected to the edge area of the section of web that has already looped around the mandrel once. In this way a hose line can be formed which is provided with a helically running reinforcing element. The longitudinal edge sections of adjacent spiral windings, or the opposite edge areas of the material web, can be connected to each other overlapping. Besides an extruded profiled rim, a film strip can also be provided as material web, wherein the film strip is coiled such that adjacent edge areas overlap. In a preferred manner, the overlapping edge areas are connected to each other by welding.

According to the invention, the wall of the hose line according to the invention has an integrated sensor material. In particular, the sensor material can be completely or partially embedded in the hose wall. Alternatively it can be arranged in the form of a coating on the inside and/or the outside of the hose line or in the form of a coating of a component of the hose wall, such as a reinforcing element. It is also possible that the sensor material is arranged evenly over the entire hose wall or only in a part of it, such as a material web.

The sensor material has at least one material property which is variable depending on at least one operating parameter of the hose line to be ascertained. By “operating parameter” within the meaning of this application is meant a state variable of the hose line, which is selected in particular from the group consisting of the temperature of the hose wall, e.g. the temperature in the inside of the hose wall or the temperature on the inner surface of the hose wall, with the result that the temperature of the medium located in the hose line can be inferred; the positive or negative pressure acting on the hose wall; the integrity of the hose wall; the bend radius of the hose line; the elongation or compression of the hose line; the vibration to which the hose line is exposed; and the degree of ageing of the material of the hose wall. The sensor material is formed such that it is suitable for determining at least one operating parameter.

The hose line according to the invention thus has the great advantage that, because of the sensor material contained in the hose wall, one or more desired operating parameters of the hose line can be determined in a simple manner directly and without the use of external measuring probes.

The sensor material is preferably in the form of at least one additive and/or in the form of at least one transducer.

According to a first aspect of the present invention, the sensor material is in the form of at least one additive.

In a preferred embodiment of this aspect, the additive is selected from the group consisting of thermochromic additives, piezochromic additives, piezoelectric additives, photochromic additives and mixtures thereof.

In an embodiment of this invention, the wall of the hose line comprises thermochromic additive. The term “thermochromic additive” denotes additives, in particular pigments, which change the colour impression produced by them when the temperature changes. The colour change can either comprise a change in the visually perceptible colour by changing for example the wavelength range in which light is absorbed or reflected by the additive or comprise a clear decrease or increase in the chromaticity, i.e. the colour intensity.

In the context of this invention, the colour change in the case of the thermochromic additives can be effected continuously over a particular temperature range or as a clear colour change at a specific transition temperature or in a very narrow temperature range. In a preferred embodiment, those thermochromic additives are selected which have a transition temperature in the temperature range to be detected in the respective intended use. For example, depending on the field of use of the hose line, the transition temperature can lie between −30° C. and +150° C. and e.g. be approximately −20° C., −10° C., 0° C., 10° C., 20° C., 30° C., 40° C., 50° C., 60° C., 70° C. or 80° C.

The thermochromic additive can be characterized by an irreversible thermochromism, i.e. the colour change caused by heating also persists after cooling to a temperature below the transition point, or by a reversible thermochromism, i.e. following a colour change caused by heating, the additive takes on its original colour again when cooled to a temperature below its transition temperature.

In a further embodiment, the thermochromic additive can have a so-called “memory effect”, i.e. the colour-change temperature during a temperature increase is different from that during cooling. With an application of the colour intensity dependent on the temperature, in this case a hysteresis can be observed. It is thus possible to detect when the temperature once exceeds or falls below this level, even after another change in temperature.

For example, it is provided according to the invention that in the case of a particular temperature effect the thermochromic additive changes the colour permanently or reversibly, and it is thus visually recognizable when a stipulated operating temperature has been exceeded.

The thermochromic additive is preferably an organic or inorganic additive.

In a preferred embodiment of the present invention, an organic thermochromic additive comprises (a) an electron-releasing chromatic organic compound, (b) an electron acceptor, (c) a reaction medium which determines the temperature at which the colour change reaction of component (a) with component (b) takes place and, optionally, (d) a colour-change temperature regulator. Examples of reversible thermochromic pigments with this type of compositions are described for example in U.S. Pat. Nos. 5,919,404, 6,494,950 and EP 1323540. Examples of thermochromic pigments with “memory effect” with this type of composition are to be found in US 2016/0130455 A1, U.S. Pat. No. 6,494,950 and US 2013/0210622 A1.

The electron-releasing chromatic organic compound (a) can be selected from a number of conventional compounds known in the state of the art such as e.g. compounds which are derived from diphenylmethane phthalide, phenylindolyl phthalide, indolyl phthalide, diphenylmethane azaphthalide, phenylindolylazaphthalide, fluoran, styryl quinoline, diazarhodamine lactone, as well as pyridine, quinazoline and bis-quinazoline compounds

The electron acceptor (b) can be selected from the group of compounds with at least one active proton, pseudo-acid compounds (compounds which are not acid but act as acid in the composition in order to bring about the development of a colour of the constituent (a)) and compounds with an electron hole as well as gallic acid esters or alkoxyphenols of formula I.

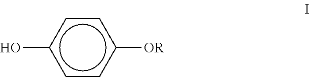

In the case of reversible thermochromic additives, the reaction medium (c) should be chosen such that it allows a reversible electron donor/acceptor reaction. In the case of reactions with “memory effect” which are to have a significant hysteresis effect, special reaction media can be used. Thus, in the context of the invention disclosed here, among other things, the esters of formula (II) described in US 2016/0130455 A1

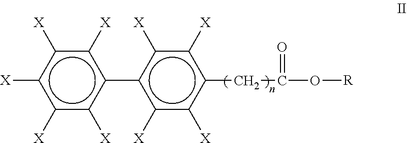

or the esters of formula III described in US 2013/0210622 A1 can be used.

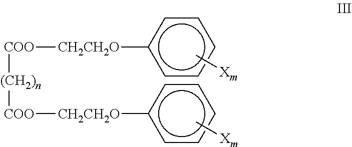

Component (d) can be selected from one or more high-melting esters, alcohols, ketones, acid amides and hydrocarbons. The colour-change temperature regulator (d) is preferably an aliphatic ester, an aliphatic ketone, an aliphatic alcohol, an aliphatic acid amide or a saturated fatty acid.

By mixing constituents (a), (b), (c) and optionally (d), a thermochromic composition is obtained, which is suitable as a thermochromic additive for use in the hose line according to the invention. The proportions of the constituents can be varied depending on the desired colour densities, colour-change temperatures and colour-change behaviour.

Furthermore, in the context of this invention, thermochromic additives which contain leuco dyes can also be used. Possible leuco dyes here, among others, are dyes derived from spirolactone, fluoran, spiropyran and fulgide. Among other things, acids such as bisphenol A, parabens, 1,2,3-triazole derivatives and 4-hydroxycoumarin can be used as proton donors.

Furthermore, in the context of this invention, thermochromic pigments based on liquid crystals, such as biphenyls or cholesterol derivatives, can also be used.

In a further preferred embodiment of the present invention, the thermochromic additive comprises an inorganic thermochromic pigment.

Examples of inorganic thermochromic pigments with a continuous colour change which can be used in the context of this invention include ZnO or TiO₂.

Examples of inorganic thermochromic pigments with a specific transition temperature include copper(II) compounds which contain the complex anion [CuCl₄]²⁻. An example of this class of compounds is bis(diethylammonium)tetrachlorocuprate(II), [(C₂H₅)₂NH₂]₂[CuCl₄], which exhibits a colour change from green to yellow at 43° C.

Further examples of inorganic thermochromic pigments include HgI₂, AgI, Ag₂HgI₄, CdS, CdSe and Cu₂HgI₄.

In a further embodiment of the invention, the wall of the hose line comprises photochromic additive. The term “photochromic additive” here denotes additives, in particular pigments, which change their generated colour impression when irradiated with UV light, by reversibly or irreversibly changing for example the wavelength range in which light is absorbed or reflected by the additive. For example, it is provided according to the invention that, following a particular light incidence quantity, the photochromic additive changes the colour permanently, and thus it becomes visually recognizable when a stipulated period of operation or use of the hose line has been exceeded. The degree of ageing of the hose wall can thus be ascertained. In addition, photochromic additives can also be used in order to protect the hose line from UV ageing or to delay this, through their colour change.

Depending on the desired field of use of the hose line, the photochromic additive can comprise organic and/or inorganic photochromic pigments.

Examples of suitable photochromic additives comprise compounds which are derived from the group of the azobenzenes, salicylideneanilines and fulgides. Further examples of suitable photochromic additives comprise compounds which are derived from spiro compounds, such as e.g. compounds from the group of the spiropyrans, such as for example spiroindolinebenzopyran, or spirooxazines, such as for example spiroindoline naphthoxazine and spiroindoline pyridobenzoxazine. In a further embodiment, the photochromic additive comprises esterification products of acrylic acid or methacrylic acid and a polyol, e.g. a diol, triol or tetracarbinol, as described in WO 89/05464. Alternatively, photochromic pigments can be used, as described in US 2005/0066453 A1.

In a further preferred embodiment of the invention, the wall of the hose line comprises a piezochromic additive. The term “piezochromic additive” here denotes additives, in particular pigments which, due to a change in their spatial extent, for example as a result of the effect of a mechanical pressure, change the colour impression generated by them, by changing for example the wavelength range in which light is absorbed or reflected by the additive. Depending on the intended use of the hose line, the colour change can be effected continuously over a wide pressure range or at a specific transition pressure or within a very narrow pressure range. In a preferred embodiment, the piezochromic additive is selected such that its transition pressure lies in the pressure range to be detected or in the range of the mechanical load to be detected. For example, the piezochromic additive has a transition pressure of <0.3 bar, <0.4 bar, <0.5 bar, <1 bar, <2 bar, <5 bar or <10 bar. For example, it is provided according to the invention that, in the case of a particular pressure effect, the piezochromic additive changes the colour permanently, and thus it becomes visually recognizable when a stipulated bend radius of the hose line, a stipulated elongation or compression of the hose line or a stipulated operating pressure of the hose line has been exceeded.

In the context of this invention, the piezochromic additive can be an inorganic or organic piezochromic pigment. Examples of suitable piezochromic additives comprise inorganic single crystals, such as e.g. crystalline salts such as LiF or NaCl. The inorganic salt CuMoO₄, which exhibits a colour change from green to red at a pressure of 2.5 kBar, constitutes a further example.

In embodiments in which a colour change at lower pressures is desired, organic polymer materials are generally preferred as piezochromic pigments.

An example of an organic piezochromic additive is poly(3-dodecyl thiophene), which exhibits a bathochromic absorption shift when the pressure changes from standard pressure to 8 kBar. Poly[3-(1-dodecyl)thiophene-2,5-diyl] also exhibits a bathochromic shift in the absorption when pressure rises from standard pressure to 10.71 GPa.

Examples of suitable piezochromic additives also comprise poly(3-dodecyl thiophene), poly[3-(1-dodecyl)thiophene-2,5-diyl] as well as piezochromic additives such as are described in WO 2005/092995, in which a piezochromic system consisting of an ionochromic substance and a developer is used, wherein an electron-donor system is formed. pH-sensitive dyes or leuco dyes such as e.g. phthalide derivatives, or derivatives of imidazole, pyrrole, bianthrone, xanthylidene anthrone, dixanthylene or helianthrone, can be used as ionochromic substances.

Further examples of suitable piezochromic additive are described in DE 10 2009 035 363 A1. Alternatively, a mixture of cholesteryl oleyl carbonate, cholesteryl chloride and cholesteryl nonanate can be used as piezochromic additive, wherein, in a preferred embodiment, these three compounds are used in a weight percent ratio of 13.9:32.9:53.2.

In a further preferred embodiment of the invention, the wall of the hose line comprises a piezoelectric additive. The term “piezoelectric additive” here denotes additives, in particular pigments, in which an elastic deformation, e.g. due to a pressure or a mechanical load, leads to a change in the electric polarization and thus to the occurrence of an electric voltage on the additive solids. For example, it is provided according to the invention that in the case of a particular pressure or temperature effect the piezoelectric additive changes its electrical behaviour permanently or reversibly, and thus it becomes visually recognizable when a stipulated operating temperature, a stipulated bend radius of the hose line, a stipulated elongation or compression of the hose line or a stipulated operating pressure of the hose line has been exceeded, based on the changed electrical behaviour. In this way, a vibration of the hose line can also be made recognizable.

In the context of this invention, the piezoelectric additive can be an inorganic or organic additive.

In a preferred embodiment, the piezoelectric additive is a piezoelectric crystal such as for example quartz, lithium niobate, berlinite, minerals of the tourmaline group or potassium sodium tartrate.

Further examples of suitable piezoelectric additives include piezoelectric synthetic ceramic materials, such as (modified) lead-zirconate-titanates (PZT), barium titanates (BTO) or lead magnesium niobates (PMN), or other piezoelectric materials, such as polyvinylidene fluoride (PVdF).

In a further preferred embodiment, the piezoelectric additive can be a piezoelectric composite material, in which particles of a strongly piezoelectric material are held together in a matrix of a structured material. Alternatively, piezoelectric thin films made of e.g. zinc oxide (ZnO) or aluminium nitride (AlN) can also be used.

The thermochromic, photochromic, piezochromic or piezoelectric additives described above are preferably added to a plastic composition in the form of a master batch before or during an extrusion process. The additive can thus be evenly introduced, in a simple manner, into a plastic which later forms the wall of the hose line or a desired part of the hose wall, such as e.g. a coating on the inside or outside of the hose line, a coating of a reinforcing element or a coating of a woven fabric, or a desired part of a hose coupling, such as e.g. a fitting.

In a preferred embodiment, the thermochromic, photochromic, piezochromic or piezoelectric additives are present in a microencapsulated form. For the microencapsulation, conventional techniques known in the state of the art can be used. Examples of these include an interface polymerization, in situ polymerization, a hardening coating in liquid, a phase separation from an aqueous solution, a phase separation from an organic solvent, a melting-dispersion cooling, an air suspension coating and spray drying. Before the microencapsulation is brought to a use within the meaning of this invention, its surface can be coated with an additional resin film, in order thereby to increase durability or to modify the surface properties and thus to improve compatibility with the plastic of the hose wall and the introduction of the additive.

In an embodiment, the additive can furthermore additionally contain a light stabilizer in order to prevent photodegradation of the additive composition and thus to increase the longevity of the hose line according to the invention. Examples of the light stabilizer include compounds which inhibit oxidation reactions, such as e.g. ultraviolet absorbents and antioxidants. The light stabilizer can also be microencapsulated together with the additive.

In a further embodiment, the additive can additionally be encased, i.e. surrounded by one or more inorganic or organic casings. The shell can contain, for example, silicon oxide, aluminium oxide, tin oxide, titanium oxide, aluminium phosphate, aluminium zinc phosphate, an organopolysiloxane, silicon nitride, silicon carbide and/or aluminium nitride.

According to a particularly preferred embodiment of the hose line according to the invention, the wall has at least one layer which comprises a thermoplastic material, wherein one or more of the additives described above are contained in the thermoplastic material.

The layer can be, for example, a coating of the inner surface of the hose wall, such as e.g. a lining of a spiral hose built up of extruded profiled rims, as described e.g. in DE 10 2006 019 562. The arrangement of the additive in a coating of the surface of the hose line showing towards the hose interior has the advantage that the operating parameters of the hose wall, e.g. the temperature, can be determined directly at the contact zone between the hose wall and the medium contained in the hose line.

In the event that the additive comprises a colour-changing additive, i.e. a thermochromic, photochromic or piezochromic additive, the hose wall itself is preferably formed transparent, with the result that the colour change is also perceptible from outside.

In another embodiment, the additive is contained in a coating of the outer surface of the hose wall. Examples of such a coating comprise a protective coating or so-called abrasion protection, i.e. a coating applied from outside or a plastic profile fitted on from outside, which protects the hose line from abrasion or scratching of the outer surface. This embodiment has the advantage that the colour changes of thermochromic, photochromic and piezochromic additives are particularly perceptible.

A layer of the hose wall within the meaning of this application also includes the wall itself. Thus, in a further embodiment, the additive can be contained in the wall of a thermoplastic spiral or smooth hose described above. For example, the additive is preferably contained evenly in the extruded profiled rim of a thermoplastic hose described above. In the event that the hose wall has several layers, such as e.g. a hose which is built up according to the “sandwich construction” described above, one or more of the layers can contain the additive.

According to a further preferred embodiment of the invention, the wall of the hose line has a reinforcing element, in particular a helically running reinforcement coil, wherein the reinforcing element has a coating, in particular a coating made of thermoplastic material, and the additive is contained in the coating of the reinforcing element. In this embodiment, the reinforcing element, such as a reinforcement coil, which typically consists of metal wire or plastic, is coated with an additive in a separate step or in a step integrated into the production of the final hose line, e.g. by means of an inline or coextrusion process. The advantage of this embodiment is, in particular, that possible negative influences of the additive on the extrudability or weldability of the thermoplastic material of the actual hose wall are avoided. This applies both to embedded, i.e. internal, reinforcing elements and to external, such as e.g. welded-on, reinforcing elements.

According to a further preferred embodiment of the invention, the hose wall has a coated woven fabric, wherein the additive is contained in the coating of the woven fabric. For example it makes sense to form a woven fabric hose which is intended for high-temperature applications with a coating which comprises a thermochromic additive, in order thus to establish when the high-temperature medium exceeds the predefined temperature range.

According to the invention it is not necessary that the entire hose wall has a sensor material, such as e.g. additive. Rather, it is also possible to apply a woven fabric or film strip equipped with the additive to the hose wall. This applied strip would also be able to guarantee the monitoring of operating parameters described at the beginning.

According to a second aspect of the present invention, the sensor material is formed as a transducer.

In a preferred embodiment, the transducer is selected from the group consisting of an electrical conductor, an optical fibre, a strain gauge and combinations thereof.

Within the meaning of this application, by the term “electrical conductor” is meant an element, in particular a metallic conductor, with good electrical conductivity, which makes no substantial contribution to the mechanical strength, in particular the bending resistance and tensile strength, of the hose line. Unlike a reinforcement coil typically used in spiral hoses, the electrical conductor thus in particular makes no substantial contribution to the crown compression strength of the hose line, i.e. the resistance to compression of the hose line by an external load applied at the apex of the hose line. Consequently, the crown compression strength of the hose line is preferably not, or is only very slightly, increased by the presence of the electrical conductor in or on the hose wall.

In a preferred embodiment, the electrical conductor is formed such that it has a reinforcement factor of less than 10, particularly preferably less than 5 or 2 and in particular less than 1.5 or 1.2. The quotient of the bending force of the hose line with electrical conductor and the bending force of the corresponding hose line without electrical conductor is referred to as the reinforcement factor. For the determination, an electrical conductor to be tested is introduced helically, i.e. spirally, into a hose consisting of thermoplastic polyurethane, in particular polyester polyurethane with a hardness of 80 Shore A, with a wall thickness, according to DIN 26057, of 1.4 mm, wherein the hose line, apart from the electrical conductor, comprises no reinforcing element, such as e.g. a reinforcement coil. The bending force of this first hose line is then determined according to DIN 26057 and brought into relation with the bending force according to DIN 26057 of a second hose line, which differs from the first hose line only in that it does not comprise the electrical conductor.

The diameter of the electrical conductor, e.g. the diameter of a metal wire, is preferably less than 1 mm, particularly preferably less than 0.8, 0.7, 0.6, 0.5, 0.3 or 0.1 mm.

The electrical properties, such as e.g. the conductivity, of an electrical conductor, depend, among other things, on its length and its diameter, with the result that a change in these variables, e.g. because of a thermal length change due to heating of the hose line or because of a mechanical length change due to elongation of the hose line, gives rise to a measurable change in the electrical conductivity. For example, it is provided according to the invention that in the case of a pressure or temperature effect the electrical conductor changes its electrical conductivity, and thus a change in the operating temperature or in the operating pressure of the hose line becomes recognizable based on the changed electrical behaviour. By means of an electrical conductor used according to the invention, the integrity of the hose line can also be ascertained as, for example, damage to the hose line and thus a breakage of the electrical conductor becomes recognizable because of the greatly changed conductivity.

In a particularly preferred embodiment, the electrical conductor is a so-called thermocouple, i.e. a pair of metallic conductors made of different material, which are connected at one end. Because of the so-called thermoelectric effect, i.e. by ascertaining the electric voltage occurring at the free ends, the temperature at the connected ends can be determined.

By the term “optical fibre” within the meaning of this application is meant a guide for the transmission of light, such as e.g. a fibre optic cable. Depending on the field of use of the hose line, the optical fibre can have a diameter of from a few micrometres to a few millimetres. The optical properties of an optical fibre depend, among other things, on its length and its diameter, with the result that a change in these variables, e.g. because of a thermal length change due to heating of the hose line or because of a mechanical length change due to elongation of the hose line, gives rise to a measurable change in the optical conductivity. For example, it is provided according to the invention that in the case of a pressure or temperature effect the optical fibre changes its optical conductivity, and thus a change in the operating temperature or in the operating pressure of the hose line becomes recognizable based on the changed optical behaviour. By means of an optical fibre used according to the invention, the integrity of the hose line can also be ascertained as, for example, damage to the hose line and thus a breakage of the optical fibre becomes recognizable because of the greatly changed conductivity.

In a particularly preferred embodiment, the optical fibre is a fibre optic sensor and in particular an inherent fibre optic sensor such as e.g. a fibre optic pressure sensor, in which pressure-induced bending losses lead to transmission changes in the glass fibre, or a fibre optic temperature sensor for the spatially resolved temperature measurement due to temperature-dependent Raman scattering in the glass fibre.

In a preferred embodiment, an electrical conductor and/or optical fibre extends in the axial direction of the hose line. It is particularly preferred that the electrical conductor and/or optical fibre extends parallel to the hose axis or helically about the hose axis. In particular, it is preferred that the wall comprises a thermoplastic material and the electrical conductor and/or optical fibre are embedded in the thermoplastic material. An advantage of the last-named embodiment is that such a hose line can be provided particularly simply, in that a plastic melt is fed into an extrusion head in order to form an extruded material web, and the electrical conductor and/or the optical fibre is connected to the material web when the material web is extruded. If the hose line has a reinforcement coil, the electrical conductor and/or the optical fibre is preferably introduced into the material web at a defined distance from the reinforcing element.

According to an alternative embodiment, the hose wall has a woven fabric and the electrical conductor and/or the optical fibre are woven into the woven fabric. This embodiment is also to be realized simply and efficiently by means of typical weaving processes.

If an electrical conductor is used as transducer, it is moreover preferred if the hose wall has a woven fabric and the electrical conductor is formed thread-like, e.g. as a conductive yarn, and is stitched to the wall or a carrier material applied to the wall. In this embodiment, the electrical conductor preferably has a thread diameter of from a few micrometres to a few tenths of a millimetre, such as e.g. 10 μm to 0.5 mm or preferably 50 μm to 0.3 mm. A loop-type arrangement of the electrical conductor, for example, is suitable as stitching pattern. According to an embodiment, the stitched sensor material is arranged on the inside of the hose.

In the case of a stitched sensor material, the electrical properties, such as e.g. the conductivity, of the electrical conductor depend not only on its length and its diameter, but also on its relative arrangement in the stitching pattern, with the result that a change in the stitching pattern, e.g. because of a thermal length change due to heating of the hose line or because of a mechanical length change due to elongation, pressures or vibrations, is accompanied by a measurable change in the electrical conductivity. Consequently, it is possible that in the case of a pressure or temperature effect the stitched sensor material changes its electrical conductivity, and thus a change in the operating temperature or in the operating pressure of the hose line becomes recognizable based on the changed electrical behaviour.

According to a further embodiment, a strain gauge is attached to the hose wall. The strain gauge can preferably be connected to the hose wall or a hose coupling or a fitting thereof by sewing, gluing or other joining techniques.

Strain gauges are known in the state of the art and constitute devices for recording elongation and compression deformations. Already in the case of small deformations, they change their electric resistance, with the result that it is possible to use the size of the electrical resistance, to infer deformations of the hose line because of a pressure applied inside the hose, or because of a elongation or compression of the hose line.

Whereas in the case of flexible hose lines which contain a colour-changing additive, e.g. a thermochromic, photochromic or piezochromic additive, as sensor material the operating parameter can already be ascertained purely optically, hose lines with transducers or electrically reactive function additive as sensor material preferably have a connector and a periphery for assessing the e.g. electrical or optical signals.

In a particularly preferred embodiment, the flexible hose line according to the invention thus further comprises a device for recording measurement data representing the material properties of the sensor material as well as, optionally, a device for transmitting the measurement data to a data processing device.

The device for recording measurement data representing the material properties of the sensor material is thus preferably suitable for recording the electrical or optical behaviour of the sensor material. For example, the device for recording measurement data representing the material properties of the sensor material constitutes an electrical ohmmeter or continuity tester which is electrically conductively connected to the sensor material, such as e.g. a layer of the hose wall containing piezoelectric additive, or an electrical conductor or strain gauge.

The measurement data recorded by the device can be indicated directly on the device and thus directly on the hose line e.g. by means of a display. It is also possible to transmit the measurement data by means of a cable or wirelessly to a storage device or a data processing device.

In a preferred embodiment, the hose line according to the invention thus further has a storage device and/or a device for transmitting the measurement data to a data processing device.

In an embodiment, an identifier clearly identifying the hose line is stored in the storage device, wherein the device for recording measurement data representing the material properties of the sensor material and the storage device are connected to the data transmission device for data telecommunication, with the result that the identifier can be interrogated via the data transmission device. In particular, it is preferred that the device for recording measurement data representing the material properties of the sensor material is set up to store data representing the operating history of the hose line including operating times and measurement data for operating parameters, or operating variables derived therefrom, in the storage device.

Furthermore, the device for recording measurement data representing the material properties of the sensor material is preferably set up to automatically send measurement data together with the identifier retrieved from the storage device periodically via the data transmission device or, in response to an external interrogation signal to the data transmission device, via the latter.

In a preferred embodiment, the storage device is a so-called RFID chip which is integrated in the hose wall or in a fitting.

A great advantage of the hose line according to the invention described above is that the user can readily combine the disclosed system for monitoring the operating parameters of the hose line with an existing system for controlling the conveying properties of the hose line, with the result that the outlay on the implementation of the system and the acquisition of additional electronic components is minimal.

In an embodiment, the hose line according to the invention has a combination of two or more of the above-named sensor materials, such as a combination of two or more additives, e.g. a combination of a thermochromic additive and a piezoelectric additive, a combination of two or more transducers, e.g. a combination of optical fibres and electrical conductors, or a combination of one or more additives with one or more transducers.

As shown above, the sensor material described above is outstandingly suitable for ascertaining operating parameters of hose lines. Accordingly, the present invention also relates to the use of sensor material integrated in the wall of a hose line, which has a material property that varies with an operating parameter of the hose line to be ascertained, for monitoring operating parameters of flexible hose lines. Consequently, the invention also relates to the use of the flexible hose line according to the invention for determining and monitoring operating parameters of the hose line.

Furthermore, the invention also relates to a method for producing a hose line according to the invention, in which the sensor material is brought into or onto the hose wall before, during or after the manufacture of the flexible hose line. Preferred aspects of the production method according to the invention are disclosed above in connection with the description of preferred sensor material.

In the following, the present invention is explained in more detail with reference to merely preferred embodiment examples and the drawings. There are shown in:

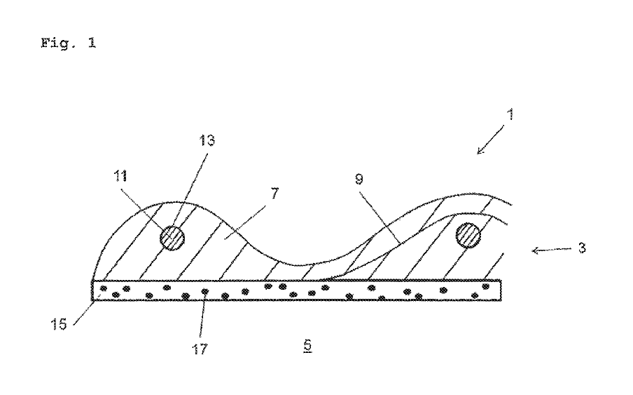

FIG. 1: a hose line according to a first embodiment of the invention in a sectional view;

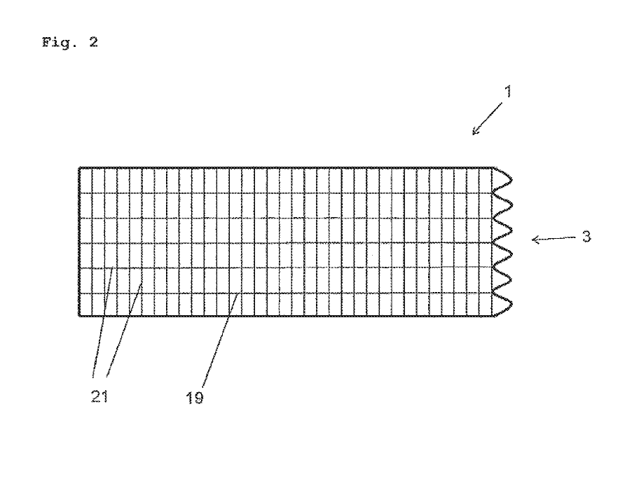

FIG. 2: a hose line according to a second embodiment of the invention in a top view;

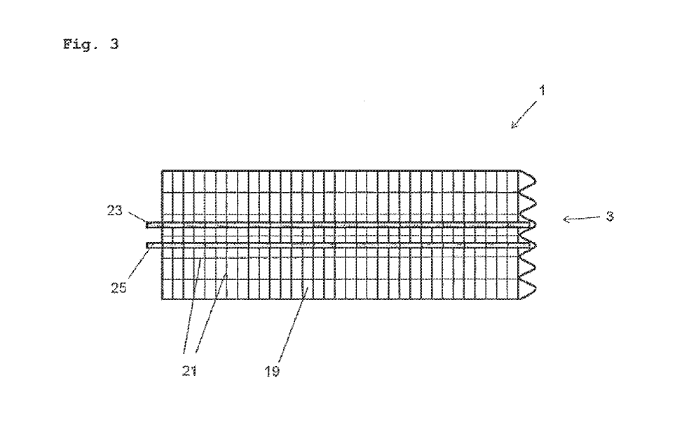

FIG. 3: a hose line according to a third embodiment of the invention in a top view; and

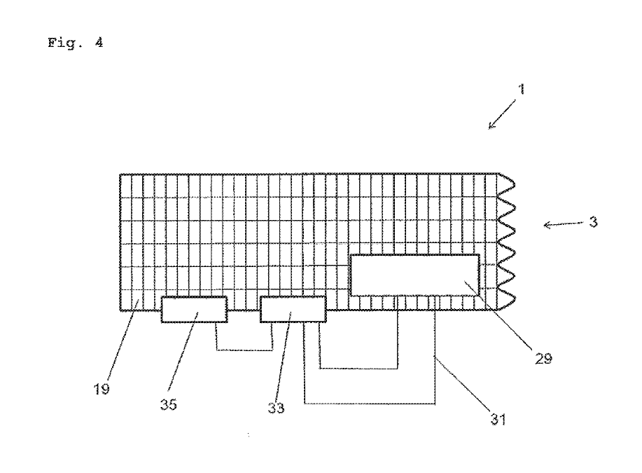

FIG. 4: a hose line according to a fourth embodiment of the invention in a top view.

FIG. 1 shows a section of a hose line 1 or of a hose with a hose wall 3, which surrounds the hose interior 5. The hose wall 3 has a helically running material web 7, which is a helically wound extruded profiled rim made of transparent thermoplastic material, wherein adjacent sections of the material web are connected to each other overlapping in the edge area 9. A reinforcing element 11 in the form of a wire spiral, which also extends helically in the hose direction or in the longitudinal direction of the hose line 1, is embedded in the material web 7.

The reinforcing element 11 has a coating 13 in which thermochromic additive is contained which is transparent up to a temperature of 80° C. and spontaneously changes its colour at a temperature higher than 80° C. In this way, an operator can quickly, cost-effectively and reliably recognize when the temperature of the wall 3 of the hose line 1 has exceeded a critical value of 80° C. The coating 13 is obtained by first coating the wire spiral of the reinforcing element 11 with the thermochromic additive and then covering it with a thin layer of a transparent plastic. Subsequently, the coated wire spiral is conveyed to a standard manufacturing method for producing spiral hoses. The fact that the additive is only contained in the coating of the reinforcing element 11 and the material web is free from thermochromic additive leads to the further advantage that the quality and reliability of the connection of adjacent material webs 7 in the edge areas 9 by means of welding and/or gluing is not negatively affected.

The hose wall 3 further has, on the surface facing the hose interior 5, a coating 15 in which a plurality of additive particles 17 are embedded. In this embodiment, the additive particles 17 also constitute a thermochromic additive, with the result that, by means thereof, the temperature of the hose wall 3 can be monitored in the area of the contact zone with the medium located in the hose interior 5. The type of colour change of the additive particles 17 preferably differs from the colour change of the additive contained in the coating 13. In any case, for this reason alone an exceeding of the temperature on the inner surface of the hose wall 3 can also differ from an exceeding of a temperature in the area of the reinforcing element 11, as the colour change caused by additive particles 17 is substantially to be observed over a large area of the coating 15 and not only in the area of the reinforcing element 11.

FIG. 2 shows a top view of a second embodiment of a hose line 1 according to the invention. In this embodiment, the hose wall 3 has a woven fabric 19 which is formed by interweaving plastic yarns 21. The plastic yarns 21 have a coating made of thermoplastic material in which thermochromic additive is contained. The detection of the exceeding of a predefined maximum operating temperature of the hose line 1 can thus be guaranteed in a simple manner by selecting a suitable thermochromic additive.

FIG. 3 also shows a hose line 1 in which the wall 3 is formed from a woven fabric 19. In this embodiment, an electrical conductor 23 and an optical fibre 25 are woven into the woven fabric 19, by interweaving the electrical conductor and the optical fibre 25 with the yarns 21. Both the electrical conductor 23 and the optical fibre 25 extend in the axial direction 27 of the hose line.

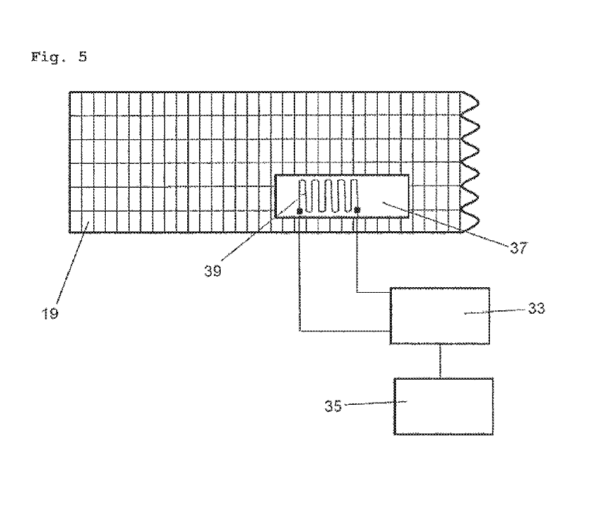

FIG. 4 also shows a hose line 1 in which the wall 3 is formed from a woven fabric 19. In this embodiment, a strain gauge 29 is secured to the woven fabric 19. The connectors 31 of the strain gauge 29 are connected to a device 33 for recording the electrical conductivity of the strain gauge 29. Furthermore, the hose line 1 has a device 35 for transmitting the measurement data to a data processing device (not shown in FIG. 5). Both device 33 and device 35 are attached to the hose line 1, with the result that the user does not need any external accessories, but the hose line 1 allows an effective and simple monitoring of operating parameters of the hose.

FIG. 5 shows a hose line 1 in which the wall 3 is formed from a woven fabric 19, to the outside of which a carrier material 37 is applied, on which an electrical conductor 39 is stitched. In the case of a pressure or temperature effect the stitched sensor material 39 changes its electrical conductivity, with the result that by means of the device 33 for recording the electrical conductivity and the device 35 for transmitting the measurement data to a data processing device a change in the operating temperature or in the operating pressure of the hose line becomes recognizable.

1. A flexible hose line with a wall, wherein the wall has integrated sensor material which has a material property that varies with an operating parameter of the hose line.

2. The flexible hose line according to claim 1, wherein the integrated sensor material is in the form of at least one additive and/or in the form of at least one transducer.

3. The flexible hose line according to claim 2, wherein the additive is selected from the group consisting of thermochromic additives, piezochromic additives, piezoelectric additives, photochromic additives and mixtures thereof.

4. The flexible hose line according to claim 2, wherein the wall has at least one layer which comprises a thermoplastic material, and the additive is contained in the thermoplastic material.

5. The flexible hose line according to claim 2, wherein the wall has a helically running reinforcing element with a coating and the additive is contained in the coating of the reinforcing element.

6. The flexible hose line according to claim 2, wherein the wall has a woven fabric and the additive is contained in a coating of the woven fabric.

7. The flexible hose line according to claim 2, wherein the at least one transducer is selected from the group consisting of an electrical conductor, an optical fibre, a strain gauge and combinations thereof.

8. The flexible hose line according to claim 7, wherein an electrical conductor and/or an optical fibre extend in the axial direction of the hose line parallel to or helically about the hose axis.

9. The flexible hose line according to claim 8, wherein the wall has at least one layer which comprises a thermoplastic material, and the electrical conductor and/or optical fibre are embedded in the layer.

10. The flexible hose line according to claim 8, wherein the wall has a woven fabric and the electrical conductor and/or optical fibre are interwoven into the woven fabric.

11. The flexible hose line according to claim 7, wherein the wall has a woven fabric and the electrical conductor is formed thread-like and is stitched onto the wall or onto a carrier material attached to the wall.

12. The flexible hose line according to claim 7, wherein a strain gauge is attached to the wall.

13. The flexible hose line according to claim 1, wherein the operating parameter of the hose line is selected from the group consisting of the temperature of the hose wall, the positive or negative pressure acting on the hose wall, the integrity of the hose wall, the bend radius of the hose line, the elongation or compression of the hose line, and the vibration and the degree of ageing of the material of the hose wall.

14. The flexible hose line according to claim 1, further comprising a device for recording measurement data representing the material properties of the sensor material.

15. The flexible hose line according to claim 14, further comprising a device for transmitting the measurement data to a data processing device.

16. The flexible hose line according to claim 2, wherein the operating parameter of the hose line is selected from the group consisting of the temperature of the hose wall, the positive or negative pressure acting on the hose wall, the integrity of the hose wall, the bend radius of the hose line, the elongation or compression of the hose line, the vibration and the degree of ageing of the material of the hose wall.

17. The flexible hose line according to claim 3, wherein the wall has at least one layer which comprises a thermoplastic material, and the additive is contained in the thermoplastic material.

18. The flexible hose line according to claim 3, wherein the wall has a helically running reinforcing element with a coating and the additive is contained in the coating of the reinforcing element.

19. The flexible hose line according to claim 3, wherein the wall has a woven fabric and the additive is contained in a coating of the woven fabric.

20. A method of monitoring an operating parameter of a flexible hose line, said method comprising the step of:
sensing a material property of a sensor material integrated in a wall of the hose line, wherein the material property varies with the operating parameter of the hose line.
